(19) United States
(12) Patent Application Publication
(10) Pub. No.: US 2002/0059874 A1
(43) Pub. Date: May 23, 2002

(54) Automated date insert for imprinting a date on a molded product

(76) Inventors: Martin Schuurman, Lakeshore (CA); Michael Munger, Harrow (CA)

Correspondence Address: Dino P. Clarizio, Dimock Stratton Clarizio, 20 Queen Street West, Suite 3202, Box 102, Toronto, ON, M5H 3R3, CA

(21) Appl. No.: 10/013,960

(22) Filed: Dec. 13, 2001

Related U.S. Application Data
(60) Provisional application No. 60/255,130, filed on Dec. 14, 2000.

(51) Int. Cl. B41J 1/00; B41L 45/00

(52) U.S. Cl. 101/72; 101/368

(57) ABSTRACT

An automated date insert is provided that imprints the date on a molded product. The automatic date insert includes a front face with attached indicators that mark a date pattern onto the surface of the molded product. Each indicator is operatively connected to an indicating means that imprints a date on the molded product that corresponds to the date pattern of the indicator. The indicating means is operatively connected to an electric motor that is activated and controlled by a processing means such that the electric motor causes the indicator means to move a pre-selected amount corresponding to a pre-determined time or date interval transmitted by the processing means.

### FIELD OF THE INVENTION

The invention relates to the field of automated date inserts, and in particular to date inserts used for imprinting the date on a molded product.

### BACKGROUND OF THE INVENTION

Date stamping devices have been in use in Canada since the early 1920's for a variety of applications. An example of one of these date stamping devices is described in Canadian Patent No. 239,784 to Marsh and Alais. This patent describes a date stamping device for printing the date on tickets. The device uses a series of wheels mounted on spindles, where the wheels are adapted to be rotated on the spindles to bring forward letters and figures into the operative position.

Date inserts have recently been used to imprint a manufacturing date on the surface of a molded product. These date inserts provide a means for imprinting the date on a molded part. These date inserts, however, require manual adjustments of the date. This task if very arduous and requires interrupting the production process and having skilled workers advance, rotate, align, and/or set up the device for the specific shift-day-month desired to be imprinted on the molded part.

Attempts have been made outside of the molding industry to create a date insert that will automatically adjust the date without needing to continuously adjust the indicator manually. However, none of these attempts have provided an efficient automated date insert that can be used in the molding industry.

There therefore remains a need to provide an automated date insert that can be used to imprint a date on a molded part and that automatically changes the date, thereby avoiding costly production interruptions.

### SUMMARY OF THE INVENTION

The automated date insert of the present invention overcomes the disadvantages of the prior art by allowing molded parts to be imprinted without stopping the molding process to advance, rotate, align and/or set up the device for the specific shift-day-month desired to be imprinted on the part.

According to one aspect of the invention, therefore, it provides an automated date insert for use in imprinting a date on a molded product, the date insert comprising a frame having a front face, wherein the frame is capable of being mounted on a mold such that the front face is in direct contact with a surface of the molded product during molding, at least one indicator operatively connected to the front face, wherein the indicator includes a date pattern that can be imprinted on the surface of the molded product during molding; indicating means movable relative to the indicator, wherein the indicating means creates an imprint on the surface of the molded product during molding that is relative to the imprint created by the indicator; an electric motor operatively connected to the indicating means; and processing means for activating and controlling the electric motor at pre-determined times or dates; whereby the electric motor causes the indicating means to move a pre-selected amount relative to the indicator corresponding to the pre-determined time or date interval transmitted by the processing means.

Various other advantages will be apparent to the person skilled in the art from the following description of the present invention read in conjunction with the accompanying drawings.

### BRIEF DESCRIPTION OF THE DRAWINGS

In drawings which illustrate by way of example only a preferred embodiment of the invention,

FIG. 1 is a top view of a preferred embodiment of the automatic date insert of the present invention.

FIG. 2 is an exploded view of the preferred embodiment of FIG. 1; and

FIG. 3 is a side isometric perspective view of the preferred embodiment of FIG. 1 in a partially exploded configuration.

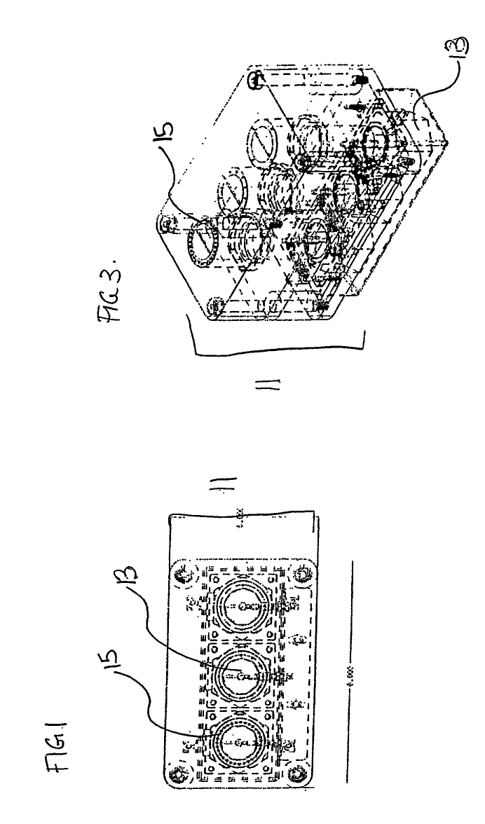

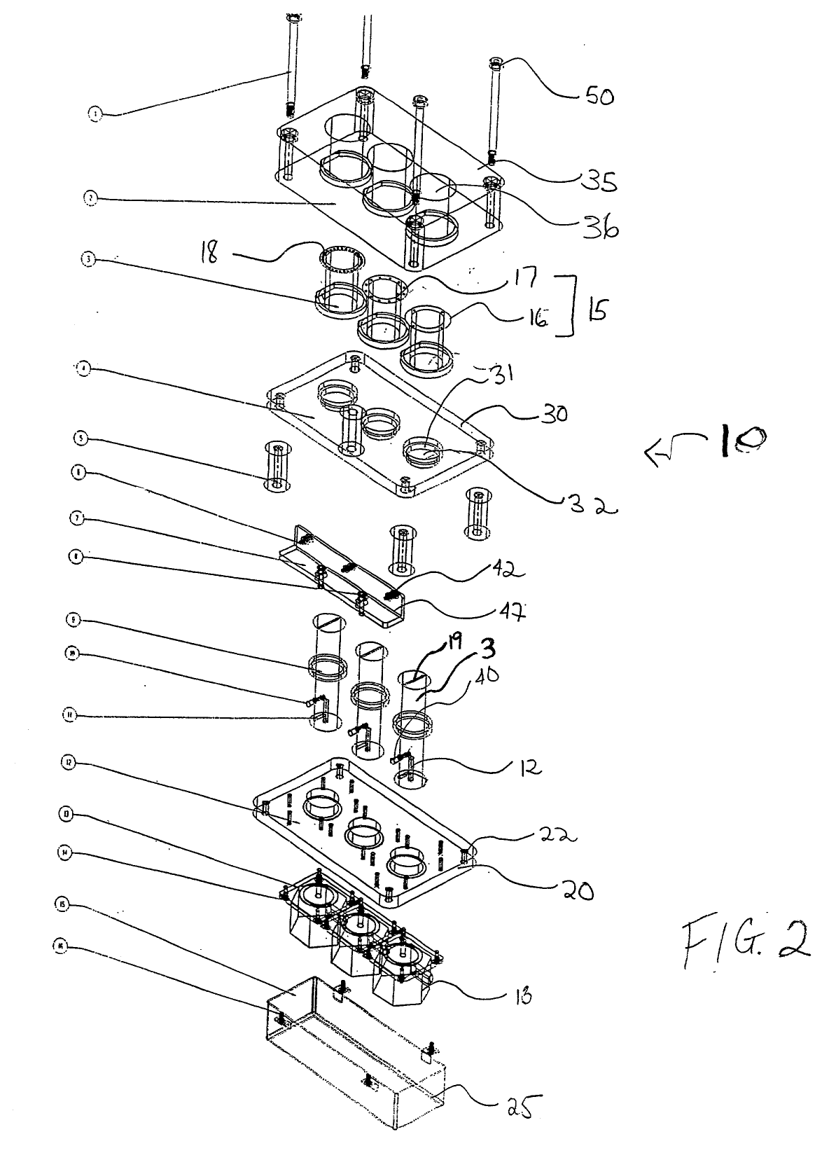

### DETAILED DESCRIPTION OF THE PREFERRED EMBODIMENT

Referring to the figures, the automated date insert 10 includes a frame 11 (which comprises a motor mounting plate 20, cover box 25, retainer plate 30 and front face 35), electric motors 13, indicating means and indicators 15.

In a preferred embodiment, the frame 11 is a box-like structure comprising a plurality of cylindrical passageways. A plurality of shafts 3 extend into the cylindrical passageways, toward an interior of a mold body. The shafts 3 include external faces, which lie flush with the internal wall of the mold body and internal faces adapted for engagement with the electric motors 13. The shafts 3 also include internal rotating pins 12 that rotate the shafts 3 about a longitudinal axis. Together the shafts 3 and internal rotating pins provide the indicating means for the automated date insert 10.

The electric motors 13 are activated and controlled by electrical signals generated by a computer processor or other processing means (not shown). Electric motors 13 cause the rotating pins 12 to rotate at selected time intervals pre-programmed into the processor. The electric motors 13 can also be programmed to automatically lock during molding and to re-start after molding. This automatic lock and re-start feature allows the motors 13 to cool, thereby avoiding problems associated with overheating, especially in blow-molding processes.

The electric motors 13 are protected from damage by a motor mounting plate 20 and cover box 25. The motor mounting plate 20 is a flat rectangular surface configured with at least three circular indentations to support the base of the motors 13. The motor mounting plate 20 is preferably made of M1 aluminum to provide a lightweight structure for supporting the motors 13.

The motor mounting plate 20 has openings at each of its corners 22 that allow for attachment of the motor mounting plate 20 to the cover box 25. The cover box 25 is mounted on the bottom of the motor mounting plate 20 to create a cover for the motors 13 and to protect the motors 13 from damage. The cover box 25 includes openings (not shown) through which electrical wiring can be inserted in order to connect the motors 13 to the computer processor.

The electrical signals transmitted to the electric motors 13, is transferred to the rotating pins 12. The Electric motors 13 cause the rotating pins 12 and shafts 3 to rotate a pre-determined distance corresponding to date and time intervals provided by indicators 15 located on an external face of the frame 11.

The indicators 15 are bushings. Shafts 3 fit inside the indicators 15 in a slip-fit relationship. Each indicator 15 has a pattern on its face that indicates, but is not limited to, a desired system to measure time (eg. shift, month, day, year, etc.). The pattern selected for the face of the indicator 15 therefore provides the press by which the date pattern is imprinted onto the outer surface of a molded part.

In a preferred embodiment, the first indicator 16 has a date pattern that indicates shift (for example, 1 =day, 2 =afternoon, 3=night, or a 24 hour clock); the second indicator 17 has a date pattern that indicates the day (1=Monday, 2 Tuesday, etc.) or the day of the month (for example, 1-31); and, the third indicator 18 has a date pattern that indicates the month, (1=January, 2=February, etc.). The first indicator 16 therefore has markings spaced at 120 degrees, representing 3 shifts in a 24-hour period. The second indicator has markings at 360 degrees/number of days in the month, and the third indicator has markings 360 degrees/12, representing the number of months in the year.

The shafts 3 include arrows 19 on their respective faces used to point to the desired markings on the indicators 15. Through computer-generated programming, the rotating pins 12 and shafts 3 will therefore be moved by the motors 13 to a position corresponding to the correct time at which the part is molded. An imprint of the arrows 19 and indicators 15 will appear on the surface of the molded part, thereby indicating the time and date when the part was molded.

On the side of each of the rotating pins 12 is a sensor pin 40. Sensor pins 40 activate proximity switches 42 when the sensor pins 40 and proximity switches 42 come into contact. Proximity switches 42 are connected to indicators 15 and automatically move the rotating pins 12 and shafts 3 to the “home position” after every full rotation of the rotating pins 12.

Sensor pins 40 are connected to a sensor pin plate 47 that has openings into which the proximity switches 42 are inserted. The motor mounting plate 20 is also used to support the sensor pin plate 47, as best shown in FIG. 3.

The indicators 15 are protected from damage by a retainer plate 30. Retainer plate 30 is a rectangular support that provides structural stability to the indicators 15 by providing three counter-bored openings 32, one for each of the indicators 16, 17, and 18. The indicators 15 are D-locked at the bottom side 31 of the retainer plate 30 to prevent any unwanted rotation of the indicators 15.

The top surfaces of the indicators 15 are protected from damage by a front face 35. Front face 35 also has three openings 36 through which the indicators 15 fit. Front face 35 sits on top of the retainer plate 30, without covering the surface of the indicators 15. The connection of the retainer plate 30 to the front face 35 therefore retains the indicators 15 in place while allowing the surface of the indicators 15 to be exposed for imprinting onto the molded part.

The various components of the automated date insert 10 are doweled and held in place by shoulder screws 50 that ensure precise alignment of all components of the automated date insert 10. A mold parts manufacturer wanting to change the pattern on one of the indicators 15 can therefore easily do so by unscrewing screws 50 and removing the front face 35, thereby providing easy access to indicators 15.

It will be apparent to a person skilled in the art that the processor can be programmed with appropriate software to allow for automatic date changes of any number of different date patterns without deviating from the invention as claimed. In addition, the processor can be set independent of the automated date insert 10 and may be located at a convenient place on or proximate to the molding machine to allow for easy operation and connection to the automated date insert 10.

In use, therefore, a person wishing to use the automated date insert 10 would pre-program the computer processor with software to change the date or time of each of the indicators 15. The automated date insert 10 is incorporated into a mold at an appropriate location so that the front face of the insert 10 causes a date pattern to be imprinted onto the surface of the molded product. One example is a blow mold used to manufacture blow molded fuel tanks for automobiles.

At a pre-determined time or date change, the computer processor activates the motors 13, which in turn cause rotating pins 12 and shafts 3 to rotate a pre-determined amount, thereby causing arrows 19 to point to the correct markings on the indicators 15, creating a new date pattern to be imprinted on the surface of the molded part. Production need not be stopped or interrupted as the date pattern is automatically changed in between cycles. This, therefore, provides significant advantages in terms of avoiding production interruptions and delays.

It will be apparent to a person skilled in the art that the automated date insert 10 can be supplied with a cooling system in order to maintain the date insert 10 at a desired temperature during the molding process. In addition, the indicators 15 may also be modified to facilitate improved temperature transfer during operation.

Numerous other variations, examples and modifications will also be apparent to a person skilled in the art and should be considered as included in the invention where all such variations, examples and modifications fall within the scope of the appended claims.

We claim:

1. An automated date insert for use in imprinting a date on a molded product, the date insert comprising:
a frame having a front face, wherein the frame is capable of being mounted on a mold such that the front face is in direct contact with a surface of the molded product during molding;
at least one indicator operatively connected to the front face, wherein the indicator includes a date pattern that can be imprinted on the surface of the molded product during molding;
indicating means movable relative to the indicator, wherein the indicating means creates an imprint on the surface of the molded product during molding that is relative to the imprint created by the indicator;
an electric motor operatively connected to the indicating means;
and processing means for activating and controlling the electric motor at predetermined times or dates;
whereby the electric motor causes the indicating means to move a pre-selected amount relative to the indicator corresponding to the predetermined time or date interval transmitted by the processing means.

2. The automated date insert of claim 1, wherein the indicating means comprises at least one shaft with an internal rotating pin.

3. The automated date insert of claim 1, wherein the processing means is a microprocessor that generates an electrical signal used to activate and control the electric motor.

4. The automated date insert of claim 1, wherein the frame further comprises a motor mounting plate, motor cover box and indicator retaining plate.

5. The automated date insert of claim 1, comprising three indicators, three indicating means, and three electric motors.

6. The automated date insert of claim 5, wherein the indicators have respective date patterns relating to a shift, a day, and a month.

7. The automated date insert of claim 5, wherein the indicators have respective date patterns relating to an hour, a day, and a month.
